(19) United States
(12) Patent Application Publication
(10) Pub. No.: US 2026/0107875 A1
(43) Pub. Date: Apr. 23, 2026

(54) METHOD OF PLANTING FORAGE CROPS

(71) Applicant: Russell Hamann, Clear Lake, SD (US)

(72) Inventor: Russell Hamann, Clear Lake, SD (US)

(21) Appl. No.: 18/918,884

(22) Filed: Oct. 17, 2024

(51) Int. Cl. A01C 1/06; A01C 7/00; A01C 21/00; A01G 20/00; A01G 24/60

(52) U.S. Cl. CPC A01C 21/00; A01G 7/00; A01K 29/00

(57) ABSTRACT

A method of dispersing seeds of a plant via a digestive system of an animal includes steps of feeding the seeds to the animal, positioning the animal in a pasture, and dispersing, via defecation by the animal, the seeds onto the pasture, whereby the seeds are mixed with manure produced by the animal. The seeds may be for a forage crop, such as one used for forage for the animal which disperses the seeds. The method may be used to overseed areas which have already planted forage crop in order to preserve or improve the health of the population of forage crops in the pasture.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to crop planting method and more particularly pertains to a new crop planting method which disperses seeds via the digestive system of an animal.

### (2) Description of Related Art Including Information Disclosed Under 37 CFR 1.97 and 1.98.

It is often difficult to maintain the health of forage crops used for cattle and other animals. Overgrazing, droughts, invasive species and other forces can decimate fields of forage crops, and farmers often must allow a pasture planted with the forage crop to replenish before permitting animals to graze the crops again. Farmers have often dealt with this problem by cycling through different areas of a pastures such that each area has an opportunity to experience a planting and/or growth phase unperturbed by animals. Such problems may be particularly felt for native grasses, which frequently have a growing season during warm months, which coincides with the most beneficial time for animals to feed off of the crops via grazing. Instead of carefully cycling through areas of a pasture or resorting to other arduous or tedious methods to maintain the health of a forage crop, a new method is needed which makes it possible to allow animals into all areas of a pasture while simultaneously stimulating additional growth of the forage crop in the pasture.

### BRIEF SUMMARY OF THE INVENTION

An embodiment of the disclosure meets the needs presented above by generally comprising steps of feeding seeds to an animal, positioning the animal in a pasture, and dispersing, via defecation by the animal, the seeds onto the pasture, whereby the seeds are mixed with manure produced by the animal.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a flow chart of a method of dispersing seeds of a plant according to an embodiment of the disclosure. The order of each step in the method may be rearranged or performed simultaneously as suitable.

### DETAILED DESCRIPTION OF THE INVENTION

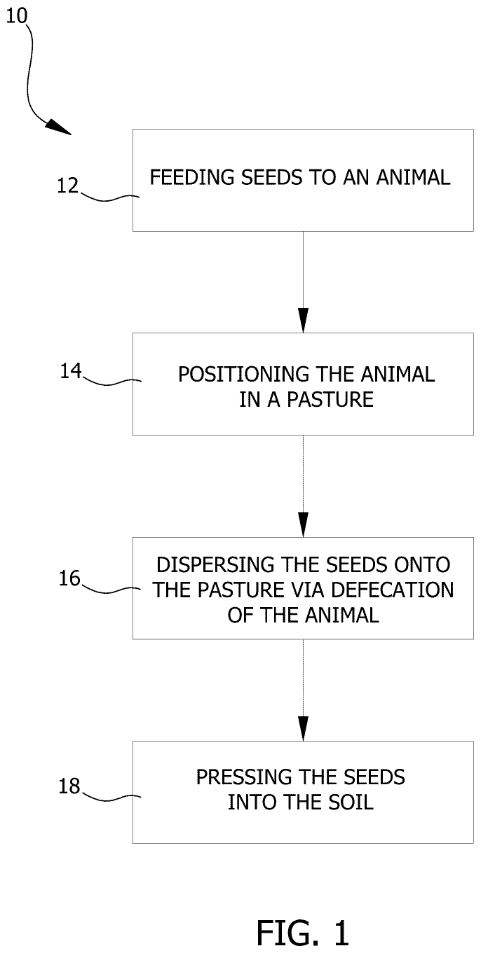

With reference now to FIG. 1 a new crop planting method embodying the principles and concepts of an embodiment of the disclosure and generally designated by the reference numeral 10 will be described.

As best illustrated in FIG. 1, the method of dispersing seeds of a plant 10 generally comprises feeding 12 the seeds to an animal, positioning 14 the animal in a pasture, and dispersing 16, via defecation by the animal, the seeds onto the pasture. As part of feeding 12 the seeds to the animal, the seeds may be incorporated into a feed mixture, such as a feed block or a loose mixture of feed elements like hay, silage, grain mixtures, pelleted feed, and the like. A feed block is known to the art and consists of a mixture formed into a solid block of edible materials for feeding livestock. Feed blocks may comprise molasses, non-protein nitrogen, rumen by-pass protein, minerals, lipids, and other supplements. Binders may be used to solidify the feed block. The plant may be a forage crop such as a grass, especially a grass native to the region wherein the pasture is located. For example, the forage crop may be panicum virgatum or switchgrass which is native to many regions in North America. The plant may, in fact, be a forage crop specifically intended as feed for the animal and the method may be performed in an area in which already planted forage crop is located. In this manner, the method may be used to overseed such areas in order to improve the likelihood of continued survival of the forage crop in the pasture.

The animal may be a ruminant, a pseudoruminant, or any animal whose digestive system is suitable for passing the seeds such that they may be planted in the pasture and may mature in the pasture under suitable conditions. For example, cattle, goats, sheep, deer, horses, or the like may be used as the animal. As the seeds are passed by the animal, the seeds will be mixed with manure, which may act as suitable fertilizer for promoting maturation and growth of the seeds such that the seeds produce plant material suitable for feeding the animal or other animals.

The seeds may be pressed 18 into the soil of the pasture via one or more animals treading upon the seeds to facilitate continued growth of the forage crop by exposure to the soil and the forage crop taking root therein. Multiple animals may be fed 12 and positioned 14 in the pasture to increase dispersal of the seeds and increase the likelihood of pressing 18 seeds into the soil. Treading upon the seeds may be done by other animals than the one or ones which dispersed 16 them via defecation. Other means may also be used to press 18 the seeds into the soil, such as driving or towing vehicles over the pasture.

The animals may be guided to particular areas of the pasture as part of positioning 14 the animals in the pasture, such as those in which already planted forage crops have become sparse in order to promote planting of the seeds in those particular areas. The animals may also be permitted or guided to graze upon already planted forage crops before, during, or after the dispersal of the seeds.

After dispersing the seeds, the plant may be allowed to grow through natural or artificial means. Additional irrigation or other processes for promoting maturation and growth of the plant may be used.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A method of dispersing seeds of a plant comprising:
feeding the seeds to an animal;
positioning the animal in a pasture;
dispersing, via defecation by the animal, the seeds onto the pasture, whereby the seeds are mixed with manure produced by the animal; and
wherein the seeds are part of a feed mixture, wherein the feed mixture is a feed block.

2. (canceled)

3. (canceled)

4. The method of claim 1, wherein the plant is a forage crop.

5. The method of claim 4, wherein the forage crop is intended as feed for the animal.

6. The method of claim 4, wherein the forage crop is a type of grass.

7. The method of claim 6, wherein the type of grass is panicum virgatum.

8. The method of claim 1, wherein the animal is a ruminant or a pseudoruminant.

9. The method of claim 1, wherein the animal is cattle.

10. The method of claim 1, further comprising pressing the seeds into the pasture.

11. The method of claim 10, wherein pressing of the seeds occurs via action of the animal treading upon the seeds.

12. The method of claim 11, wherein:
the step of positioning the animal in the pasture further comprises positioning a plurality of additional animals in the pasture; and
the step of pressing the seeds into the pasture occurs via action of at least one of the animal and the plurality of additional animals.

13. A method of dispersing seeds of a plant comprising:
feeding the seeds to an animal, wherein the seeds are part of a feed mixture, wherein the feed mixture is a feed block, wherein the plant is a forage crop, the forage crop being a type of grass, the type of grass being panicum virgatum, wherein the animal is cattle;
positioning the animal in a pasture;
dispersing, via defecation by the animal, the seeds onto the pasture, whereby the seeds are mixed with manure produced by the animal; and
pressing the seeds into the pasture, wherein pressing of the seeds occurs via action of the animal treading upon the seeds.
